(19) United States
(12) Patent Application Publication
(10) Pub. No.: US 2006/0192847 A1
(43) Pub. Date: Aug. 31, 2006

(54) Display apparatus, and display control method for the display apparatus

(75) Inventor: Isao Watanabe, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/329,218

(22) Filed: Jan. 11, 2006

(30) Foreign Application Priority Data
Feb. 25, 2005 (JP) 2005-050680

(51) Int. Cl. H04N 7/14

(52) U.S. Cl. 348/14.07

(57) ABSTRACT

According to one embodiment, an display apparatus comprises a display unit, an acquisition unit configured to acquire a distance between a display surface of the display unit and a viewer of the display surface, a calculation unit configured to calculate a display size of a window on the display unit based on the distance acquired by the acquisition unit, and a control unit configured to convert the window into the display size calculated by the calculation unit and to display the converted window on the display unit.

### CROSS-REFERENCE TO RELATED APPLICATIONS

This application is based upon and claims the benefit of priority from prior Japanese Patent Application No. 2005-050680, filed Feb. 25, 2005, the entire contents of which are incorporated herein by reference.

### BACKGROUND OF THE INVENTION

1. Field of the Invention

The present invention relates to a display control technique which is preferably applied to, e.g., a videophone for presenting the image of a communication partner to a speaker.

2. Description of the Related Art

Along with recent improvements in image processing and communication techniques, there is prevailing a videophone system which allows users at remote places to exchange their images photographed by cameras and enjoy conversation while seeing images of the partners. The sizes of display apparatuses used to display images of this type are diversified especially toward two, large and small sizes.

In this situation, there has recently been proposed a method of correcting an object image to a proper size in consideration of the size of the display surface on the receiving side and the distance between the display surface and the user when an image photographed on the transmitting side is displayed on the receiving side (see, e.g., Jpn. Pat. Appln. KOKAI Publication No. 2001-57671).

When the ratio (angle of view) of an image to the field of view exceeds a predetermined value in viewing an image, the user may experience symptoms (visually induced seizures) similar to motion sickness such as dizziness depending on the image. This must be taken into consideration in the use of a large screen display apparatus. In particular, the symptoms worsen when the image flickers around the focus.

In order to solve this problem, the display size of a window is preferably reduced to prevent the ratio of an image to the field of view from exceeding a predetermined value in visual observation at close range. An application of the above described method in Jpn. Pat. Appln. KOKAI Publication No. 2001-57671 will be considered.

According to the method in Jpn. Pat. Appln. KOKAI Publication No. 2001-57671, when the viewer is at close range, the object image of the transmitting user is reduced and presented. However, only the area of the object image which occupies the image is reduced, and the display size of the window does not change. The viewer may still experience visually induced seizures from, e.g., an image in which an object image flickers at the periphery.

### BRIEF SUMMARY OF THE INVENTION

According to an embodiment of the present invention, a display apparatus comprises a display unit; an acquisition unit configured to acquire a distance between a display surface of the display unit and a viewer of the display surface; a calculation unit configured to calculate a display size of a window on the display unit based on the distance acquired by the acquisition unit; and a control unit configured to convert the window into the display size calculated by the calculation unit and to display the converted window on the display unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an external view showing a videophone terminal according to an embodiment of the present invention when viewed from the front;

FIG. 2 is a block diagram showing the internal configuration of the videophone terminal according to the embodiment;

FIG. 3 is a conceptual view for explaining the basic principle of window display size conversion which is executed by the videophone terminal in accordance with the distance to the user according to the embodiment;

FIG. 4 is a view for explaining a method of ensuring a display area when the display size is reduced in the videophone terminal according to the embodiment; and

FIG. 5 is a flowchart showing the operation procedures of window display size conversion which is executed by the videophone terminal in accordance with the distance to the user according to the embodiment.

### DETAILED DESCRIPTION OF THE INVENTION

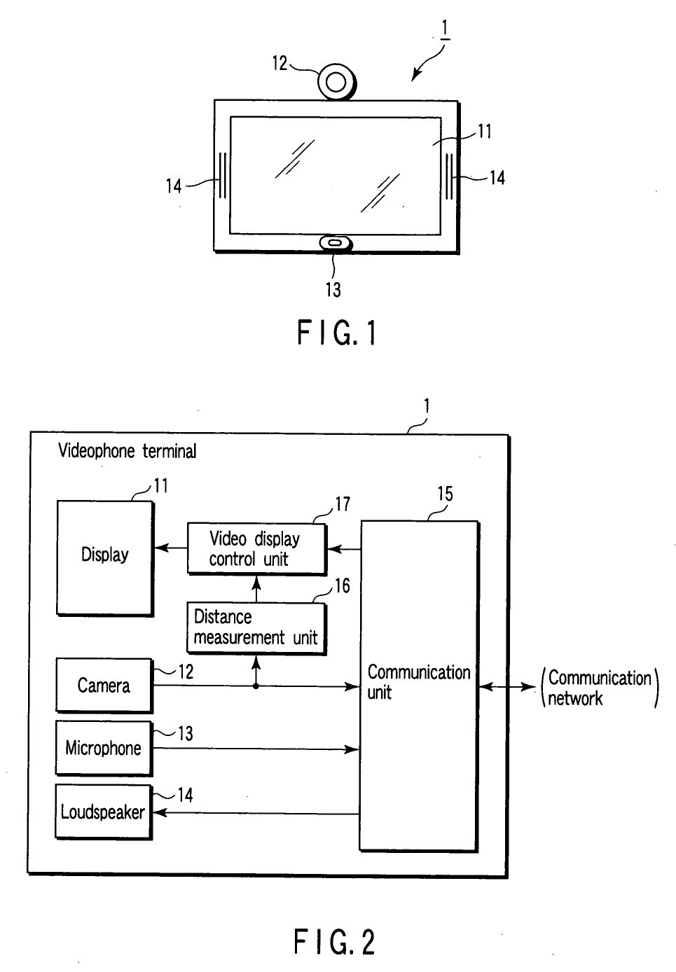

An embodiments of the present will be described below with reference to the several views of the accompanying drawing. FIG. 1 is an external view showing a videophone terminal according to the embodiment of the present invention when viewed from the front.

A videophone terminal 1 allows the user to enjoy conversation while seeing the image of a partner. As shown in FIG. 1, the display surface of a display 11 is attached to the front of the videophone terminal 1. A camera 12 is attached at the center of an upper portion on the display surface of the display 11. A microphone 13 is attached at the center of a lower portion, and loudspeakers 14 are attached on the two sides.

FIG. 2 shows the internal configuration of the videophone terminal 1. As shown in FIG. 2, the videophone terminal 1 comprises a communication unit 15, distance measurement unit 16, and video display control unit 17 in addition to the display 11, camera 12, microphone 13, and loudspeakers 14.

The communication unit 15 executes communication in order to exchange images and voice via a communication network between the videophone terminal 1 and another videophone terminal 1 used by a communication partner. The distance measurement unit 16 measures the distance to the user by using the size of an image sensed by the camera 12. The video display control unit 17 converts the display size of a partner image received by the communication unit 15 and controls display on the display 11 on the basis of the distance measured by the distance measurement unit 16.

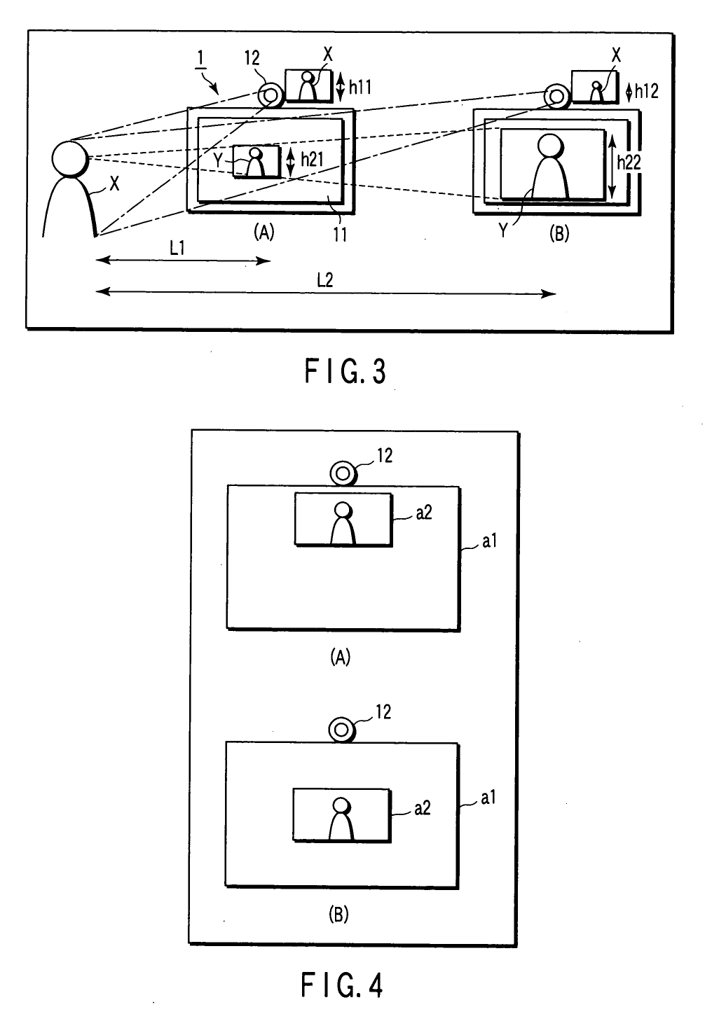

FIG. 3 is a conceptual view for explaining the basic principle of window display size conversion which is executed by the videophone terminal 1 in accordance with the distance to the user.

Assume that user X and user Y talk over the videophone terminals 1 while seeing each other's images. Attention is paid to the videophone terminal 1 of user X. More specifically, the camera 12 senses an image in which user X is an object, and the display 11 displays an image in which user Y serving as a communication partner is an object.

The videophone terminal 1 allows the user to arbitrarily register the distance (normal use distance) from the videophone terminal 1 and a window size (normal display size) at this distance in accordance with user's preferences. Information held upon registration includes a video size on the screen, and the video size of the user photographed by the unzoomed camera 12 when the user is at the normal use distance.

Upon registration, the videophone terminal 1 calculates a display magnification based on the normal video size from a user image photographed by the camera 12 and the zoom ratio of the camera 12 at that time:
(display magnification)=(camera zoom ratio)/(video size ratio) (1)

The camera zoom ratio is a numerical value representing the number of times by which the length of an object in an image is longer/shorter than an unzoomed object. The video size ratio is a numerical value representing the number of times by which the video size of the user in an image photographed by the camera 12 is larger/smaller in length than the normal video size when the camera is not zoomed at the normal use. distance.

For example, when state (A) of FIG. 3 in which the display size of user Y is defined as h21 when user X is at a distance L1 is registered as a normal state, user X moves to a distance L2 which is twice the distance L1, as shown in state (B) of FIG. 3. In this case, if the camera 12 is set at an equal magnification, the video size of user X decreases to h12 which is half a video size h11 before movement. The display magnification calculated by equation (1) is 2, and the display size of user Y on the display 11 increases to h22 which is twice the display size h21 before movement. Hence, the window size remains unchanged in appearance. Conversely, if user X comes close from the distance L2 to the distance L1 of ½, the window size of user Y on the display 11 becomes half. This also applies to a case wherein state (B) of FIG. 3 is registered as a normal state. By proper registration, the ratio (angle of view) of an image to the field of view can be made to fall within a predetermined range. Since the window size itself is reduced instead of reducing the area of an object image which occupies an image, the factor of visually induced seizures can be eliminated.

This registration is preferably done by each user. Even during use, setting of validating/invalidating automatic adjustment of the display size and enlargement/reduction of an automatically adjusted display size may be designated by user operation.

As a characteristic of the videophone terminal 1, the line of sight of the user tends to concentrate near the window. Thus, when the display size becomes smaller than a display surface al of the display 11, a window a2 is displayed as close to the camera 12 as possible, as shown in (A) of FIG. 4. The window a2 is generally ensured at the center of the display 11, as shown in (B) of FIG. 4. In this case, when the user turns his eyes to the window a2, the user is sensed while averting his eyes from the camera 12. The users cannot make conversation while meeting their eyes. To prevent this, the window a2 is ensured as close to the camera as possible.

A partner image is not always displayed at a proper size on an actual image by a videophone. For example, when the ratio of a background image to a whole image is large, a decrease in display size makes a partner image too small and makes it difficult to see the partner image. Even when the distance size is increased, the background image interferes with display of the partner image at a sufficient size.

The videophone terminal 1 solves these problems by performing processing such as motion detection or extraction of a person image for an image to be displayed, dividing the image into a part to be displayed and a background part, cropping the image, and displaying the cropped image at a necessary display size.

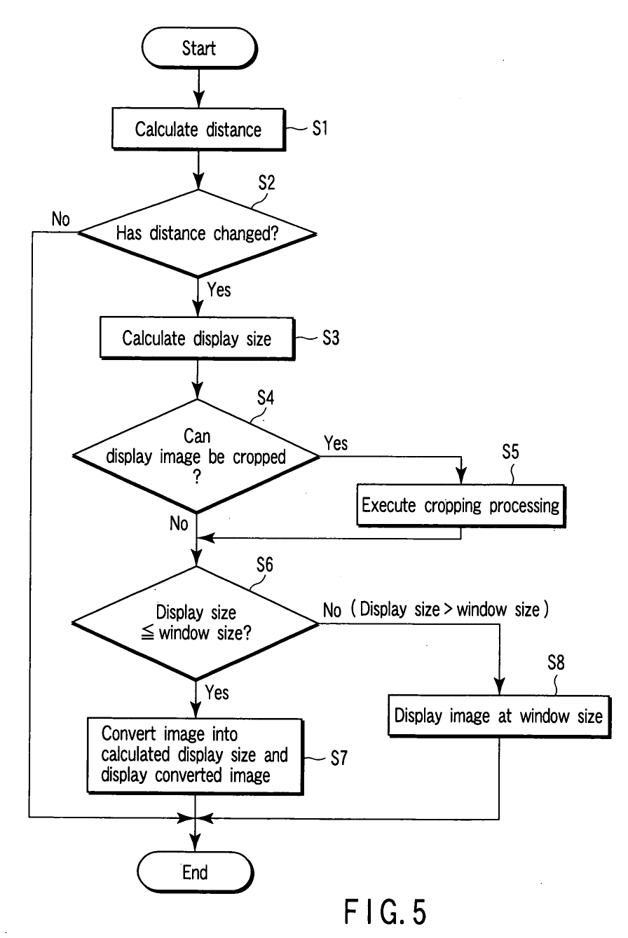

FIG. 5 is a flowchart showing the operation procedures of window display size conversion which is executed by the videophone terminal 1 in accordance with the distance to the viewer.

The distance measurement unit 16 calculates the distance to the user serving as an object by using a user image photographed by the camera 12 (step S1). The distance measurement unit 16 checks whether the distance has changed from a previously calculated one (step S2). If a change is detected (YES in step S2), the video display control unit 17 calculates a display size corresponding to the newly calculated distance (step S3).

At this time, the video display control unit 17 determines whether the image of a communication partner that is received by the communication unit 15 can be cropped (step S4). If the partner image can be cropped, the video display control unit 17 executes cropping processing to change the partner image to a proper size (step S5).

The video display control unit 17 determines whether the calculated display size is equal to or smaller than the display surface size of the display 11 (step S6). If the calculated display size is equal to or smaller than the display surface size of the display 11 (YES in step S6), the video display control unit 17 converts the image into the calculated display size, and displays the image on the display 11 (step S7). If the calculated display size is larger than the display surface size of the display 11 (NO in step S6), the video display control unit 17 displays the image at the display surface size of the display 11 (step S8).

The above processing is repetitively executed, e.g., every predetermined period or every predetermined timing.

In this manner, the videophone terminal 1 can appropriately control, in accordance with the distance from the viewer, the window size of an image to be displayed.

An example of calculating the distance from an image sensed by the camera 12 to the user has been described. However, the present invention is not limited to this, and various methods of acquiring a distance, such as a method of irradiating an object with an infrared ray and measuring the distance from the reflection state, can be applied. In other words, the present invention is not limited to the videophone terminal 1, and can also be applied to, e.g., a television apparatus having no camera 12.

The window size need not be reduced/enlarged linearly in correspondence with a decrease/increase in calculated distance, and may be switched stepwise. For example, the display size can be effectively switched in two steps between a case wherein the user is in a given distance and a case wherein the user is apart by the distance or more. As another switching form, the minimum value of the display size can also be set to 0, i.e., no image is displayed. With this setting, it can be controlled to turn off the display when, for example, a child comes close to the screen more than necessary.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display apparatus comprising:
a display unit;
an acquisition unit configured to acquire a distance between a display surface of the display unit and a viewer of the display surface;
a calculation unit configured to calculate a display size of a window on the display unit based on the distance acquired by the acquisition unit; and
a control unit configured to convert the window into the display size calculated by the calculation unit and to display the converted window on the display unit.

2. The display apparatus according to claim 1, wherein the calculation unit calculates the display size of the window so as to decrease the display size of the window as the acquired distance decreases and increase the display size of the window as the acquired distance increases.

3. The display apparatus according to claim 1, wherein the calculation unit calculates the display size of the window so as to decrease/increase the display size of the window stepwise between n predetermined display sizes.

4. The display apparatus according to claim 1, wherein the calculation unit calculates the display size of the window so as to convert the display size of the window in order to keep a size viewed from the viewer constant.

5. A display apparatus comprising:
a display unit;
an image sensing unit, arranged at a periphery of a display surface of the display unit, configured to sense an image in which a viewer of the display surface is an object;
a calculation unit configured to calculate a display size of a window on the display unit based on a size of an object image in the image sensed by the image sensing unit, and a zoom ratio of the image sensing unit upon sensing the image; and
a control unit configured to convert the window into the display size calculated by the calculation unit and to display the converted window on the display unit.

6. The display apparatus according to claim 5, wherein the control unit displays the reduced image on the display unit so as to locate the reduced image closer to the image sensing unit on the display surface of the display unit, when the control unit reduces the window to the display size calculated by the calculation unit.

7. The display apparatus according to claim 5, wherein the calculation unit calculates the display size of the window so as to increase the display size of the window as the object image in the sensed image decreases and to decrease the display size of the window as the object image in the sensed image increases.

8. The display apparatus according to claim 5, wherein the calculation unit calculates the display size of the window so as to decrease/increase the display size of the window stepwise between n predetermined display sizes.

9. The display apparatus according to claim 5, wherein the calculation unit calculates the display size of the image so as to convert the display size of the image in order to keep a size viewed from the viewer constant.

10. A display control method for a display apparatus, comprising:
acquiring a distance between a display surface and a viewer of the display surface;
calculating a display size of a window on the basis of the acquired distance; and
converting the window into the calculated display size to display the converted window.

11. A display control method for a display apparatus, comprising:
sensing an image in which a viewer of a display surface is an object;
calculating a display size of a window on the basis of a size of an object image in the sensed image, and a zoom ratio used to sense the image; and
converting the window into the calculated display size to display the converted window.
